(19) United States
(12) Patent Application Publication
(10) Pub. No.: US 2005/0055547 A1
(43) Pub. Date: Mar. 10, 2005

(54) Remote processor

(75) Inventor: Yuuichi Kawamura, Tokyo (JP)

Correspondence Address: FRISHAUF, HOLTZ, GOODMAN & CHICK, PC, 767 THIRD AVENUE, 25TH FLOOR, NEW YORK, NY, 10017-2023, US

(73) Assignee: Konica Minolta Business Technologies, Inc., Tokyo (JP)

(21) Appl. No.: 10/831,634

(22) Filed: Apr. 23, 2004

(30) Foreign Application Priority Data
Sep. 10, 2003 (JP) 2003-318134

(51) Int. Cl. G06F 11/30

(52) U.S. Cl. 713/155; 713/201

(57) ABSTRACT

A remote processor for executing processing requested from a client via a network, wherein an access right is authenticated using authenticating information generated by combining user-configurable user setting information such as a user name and a password with device-specific information specific to the client such as a MAC address to improve security for remote accesses. An initial access is authenticated using user setting information specified by an administrator. If the authentication is successful, the device-specific information of the client is automatically acquired and registered. Subsequent accesses are authenticated by using the user setting information and the device-specific information as conditions logically ANDed together for the access right authentication.

### BACKGROUND OF THE INVENTION

1. Field of the Invention

The present invention relates to a remote processor such as a printer or a digital complex machine for executing processing requested from a client via a network, and more particularly to a remote processor having an access right authenticating function.

2. Description of the prior Arts

An image forming apparatus such as a complex machine having a copying function, a scanner function, a printer function, and the like has a function of executing various jobs in response to a request sent from a client connected via a network. For example, this kind of machine executes a print job on the basis of print data received from a client at a personal computer or executes an e-mail transmission job for transmitting an original image having been read to a specified destination by means of e-mail on the basis of a processing request from a client.

Generally, a user ID and a password are used for the access right authentication in response to a remote access as stated above. In case a large number of image forming apparatuses are connected on the corporate network, a dedicated management server installed in the network is used for the management of the access right authentication for all the large number of image forming apparatuses.

There has been suggested an information processing system in which transmitted data have unique identification information appended which is not duplicated in the network and an information management server consolidates the identification information in order to enhance the security of image information or other data transmitted between devices connected on the network (Refer to Japanese Unexamined Patent Publication (Kokai) No. 2001-45274, for example). If a client requests the information management server to give the identification information appended to the transmitted data in this system, the information management server generates identification information made of a media access control (MAC) address of the client combined with date information of the request reception. Since the MAC address is information useful for identifying the client uniquely on the network, the unique identification information on the network is generated with the combination of the MAC address and the date information.

### SUMMARY OF THE INVENTION

In a case of authenticating an access right by using only user-configurable information such as a user ID and a password, the access right authentication is performed also for a different client (terminal) of an access source. It conveniently enables an access from any client if the user is the same person, while the security, however, deteriorates in return for the convenience. While the security is improved by increasing an amount of information required for the authentication, it increases an operational burden for inputting the authenticating information.

Managing all access rights in the dedicated management server provided on the network enables consolidating access logs, thus reducing the management burden. Providing the dedicated management server, however, complicates the system configuration. In addition, it has a problem that an occurrence of a failure in the management server stops the functions of the entire system. Furthermore, if the management server is requested to authenticate an access right via the network for each job execution, it takes a long time to complete the authentication, thereby deteriorating the response to a processing request from a user. Still further, if authentication requests are sent at a time from a large number of clients, there can be assumed a case that it disables a smooth execution of the authentication processing since the management server takes a heavy load exceeding its processing power.

To resolve these problems, the present invention has been provided. Therefore, it is an object of the present invention to provide a remote processor capable of improving the security for remote accesses without increasing an operational burden for inputting authenticating information, eliminating the necessity of an installation of a dedicated management server, and reducing the management burden on an administrator.

According to a first aspect of the present invention, there is provided a remote processor for executing processing requested from a client via a network, comprising: authenticating information registration means (40) having authenticating information registered, which is a combination of user-configurable user setting information and device-specific information specific to the client; and authentication means (33) for authenticating an access right by comparing information for use in the authentication acquired from the client with the authenticating information registered on the authenticating information registration means (40) upon receiving a processing request from the client.

With the above features of the invention, upon receiving the processing request from the client, the access right is authenticated by using the authenticating information made of the user-configurable user setting information combined with the device-specific information specific to the client. The user setting information can be any information only if a user can select or set the information such as a user name, a user ID, a password or any other user key, and an e-mail address. The device-specific information can be a MAC address of the client, an Internet protocol (IP) address, a device manufacturing number, or the like. The device-specific information can be any information only if a user cannot arbitrarily change the setting and the client can be uniquely identified based on it.

By using the combination of the user setting information and the device-specific information as authenticating information, a user and a client become targets of the access right authentication as logically ANDed conditions. Therefore, the security for remote accesses is improved in comparison with right access authentication only based on user authentication. In addition, a MAC address and an IP address are automatically transmitted from the client of the access source and therefore this feature does not increase an operational burden on the user regarding an input of the authenticating information.

Furthermore, the authenticating information is registered in the remote processor and the access right is authenticated by the remote processor that has received an access request from the client. Therefore, there is no need to provide an authentication management server separately, thus preventing problems of a delay in response, a shutdown of the entire system caused by a failure of a management server, a concentration of loads on the management server, and the like.

According to a second aspect of the present invention, there is provided a remote processor for executing processing requested from a client via a network, comprising: initial authenticating information registration means (41) having initial authenticating information registered for initially authenticating an access right; initial authentication means (34) for authenticating the access right on the basis of the initial authenticating information upon receiving an initial registration request from the client; device-specific information acquisition means (35) for acquiring device-specific information, which is specific to the client, from the client if the initial authentication means (34) authenticates the access right; device authenticating information registration means (42) for registering the device-specific information acquired by the device-specific information acquisition means (35) as device authenticating information; and authentication means (33) for authenticating the access right by using authenticating information including a part or all of the device authenticating information upon receiving a processing request from the client.

With the above features of the invention, upon receiving the initial registration request from the client, the access right is authenticated on the basis of the initial authenticating information previously registered. If the authentication is successful, the remote processor automatically acquires the device-specific information such as a MAC address from the client and registers it as the device authenticating information. Upon receiving a processing request from the client thereafter, the remote processor authenticates the access right by using the authenticating information including a part or all of the device authenticating information.

An administrator or the like of the remote processor previously registers the initial authenticating information. User setting information such as a user ID or a password is preferable as the initial authenticating information. It is also possible to have an arrangement of accepting various information inputs or setting modifications from a user in addition to automatically acquiring the device-specific information if the access right is successfully authenticated for the initial registration request. For example, it is preferable to accept an input operation of an account name or an e-mail address or a password change operation.

The authenticating information can be made of only the device-specific information or of the device-specific information combined with the user setting information or the like. If there are a plurality of kinds of acquired device-specific information, it is possible to apply only a part of those to the authenticating information. For example, if a MAC address and an IP address are acquired, only the MAC address can be applied to the authenticating information. Regarding what kinds of information should be combined to generate the authenticating information, a fixed combination can be previously determined or the remote processor can select the information automatically. It is also possible to have an arrangement that an administrator or a user can select the information.

As stated above, if the authentication is successful on the basis of the initial authenticating information previously registered by the administrator or the like, the remote processor automatically acquires the device-specific information from the client and uses the information for the subsequent authentication. Therefore, it reduces the burden of works for investigating the device-specific information or for incorporating it in the authenticating information.

According to a third aspect of the present invention, the remote processor comprises user authenticating information registration means (43) having user-configurable user setting information (43) registered, wherein the authentication means (33) authenticates the access right by using authenticating information which is a combination of the user setting information and the device authenticating information.

With the above features of the invention, the subsequent access rights are authenticated by using the authenticating information generated by combining a part or all of the device-specific information automatically acquired at the successful authentication for the initial registration request. By using the authenticating information as a combination of the user setting information such as a user ID or a password with the device-specific information such as an MAC address or an IP address, the client of the access source is limited by the MAC address, thus improving security against unlawful accesses.

According to a fourth aspect of the present invention, the remote processor comprises enabled function registration means (44) having functions registered for enablement for each authenticating information if the access right is successfully authenticated on the basis of the authenticating information, and function limiting means (36) for limiting functions enabled for the current access to only enabled functions registered being associated with the authenticating information used for authenticating the access right if the access right is successfully authenticated.

With the above features of the invention, if the access right is successfully authenticated, enabled functions are limited individually for each authenticating information used for authenticating the access right. For example, if the remote processor has various functions such as copying, printing, facsimile, and e-mail transmission functions, enabled functions can be limited individually for each authenticating information. Preferably, the administrator previously registers contents of the functional limitations on the enabled function registration means (44). The arrangement may be such that a user whose access right has been authenticated can modify the contents of the functional limitations. In this arrangement, it is preferable to limit the user's modification to a range permitted by the administrator so that the functions are limited in a hierarchical fashion. For example, if the administrator enables a printing function, a user further limits the number of available sheets or a printing fee in order to limit the expenditure.

According to a fifth aspect of the present invention, the remote processor comprises information exchange means (38) for transferring access control information composed of information for access right authentication or function limitation between remote processors, which are connected on the same network and each having a function of authenticating an access right or limiting enabled functions by using the access control information, in order to exchange information so that the respective remote processors have all the access control information.

With the above features of the invention, the access control information registered and modified in one of the remote processors is exchanged between the remote processors connected on the same network and having a function of authenticating access rights or of limiting functions by using the access control information. This causes the respective remote processors to have all the access control information registered and modified in one of the remote processors having the same functions. As a result, the authentication or the limitation on functions is performed under the same conditions even if a user accesses any remote processor having the same functions within the same network. In addition, there is no need to send inquiries to any other remote processor or to a dedicated server about the authenticating information or the information on the functional limitations.

According to a sixth aspect of the present invention, the remote processor comprises informing means (37) for informing a given administrator's terminal of log information on the access from the client via the network.

With the above feature of the invention, the log information on the access is transmitted to the administrator's terminal via the network. This reduces the management burden on the administrator. It is preferable to use e-mail, a simple network management protocol (SNMP) trap, or the like for the informing operation. The log information includes an access log for successful access right authentication and an access log for unsuccessful access right authentication. Preferably the remote processor has an arrangement of extracting a client frequently making unlawful accesses failing in the authentication and automatically informing the administrator of the results.

According to the remote processor of the present invention, an access right is authenticated by using authenticating information generated by combining user-configurable user setting information with device-specific information specific to a client. Therefore, both of the user and the client become targets of the authentication, thereby improving security for remote accesses in comparison with a case of authenticating an access right only by user authentication. In addition, the device-specific information such as a MAC address or an IP address is automatically transmitted from the client of the access source. Therefore, the crime prevention is improved without increasing the operational burden on the user in inputting the authenticating information.

Furthermore, the authenticating information is registered in the remote processor and the access right is authenticated by the remote processor that has received an access request from the client. Therefore, there is no need to provide an authentication management server separately, thus preventing problems of a delay in response to the access request, a shutdown of the entire system caused by a failure of a management server, a concentration of loads on the management server, and the like.

According to the remote processor which performs the initial authentication on the basis of the initial authenticating information previously registered by the administrator or the like and which automatically acquires the device-specific information from the client if the authentication is successful, it is possible to reduce the work burden on the administrator or the like related to the investigation and the registration of the device-specific information.

According to the remote processor which limits functions enabled when the access right is successfully authenticated for each authenticating information used for authenticating the access right, a detailed access control is enabled by adding individual limitations on functions for each user and for each client in the remote processor having various functions.

According to the remote processors which exchange access control information therebetween, the respective remote processors retain all the access control information. Therefore, the access right authentication or the functional limitation is performed under the same conditions even if the user accesses any remote processor having the same functions within the same network. In addition, there is no need to send inquiries to any other remote processor or to a dedicated server about the authenticating information or the information on the functional limitation.

According to the remote processor which transmits log information on an access from the client to an administrator's terminal via the network, the administrator can consolidate the log information of the respective remote processors, thereby reducing the burden on the administrator.

### BRIEF DESCRIPTION OF THE DRAWINGS

FIG. 1 is an explanatory diagram showing a configuration of a network including complex machines according to an embodiment of the present invention;

FIG. 2 is a block diagram showing a configuration of the complex machine according to the embodiment of the present invention;

FIG. 3 is an explanatory diagram showing an example of a registration table registered on a management information database of the complex machine according to the embodiment of the present invention;

FIG. 4 is a flowchart of processing on an initial registration request;

FIG. 5 is a flowchart of processing performed when a user requests the complex machine of a job execution from a client PC via the network;

FIG. 6 is a flowchart of node check processing for searching for a complex machine with which information is to be exchanged within the same network; and

FIG. 7 is a flowchart of processing on information exchanges performed by an image forming apparatus according to the embodiment of the present invention.

### DETAILED DESCRIPTION OF THE PREFERRED EMBODIMENTS

The preferred embodiments of the present invention will now be described in detail hereinafter with reference to the accompanying drawings.

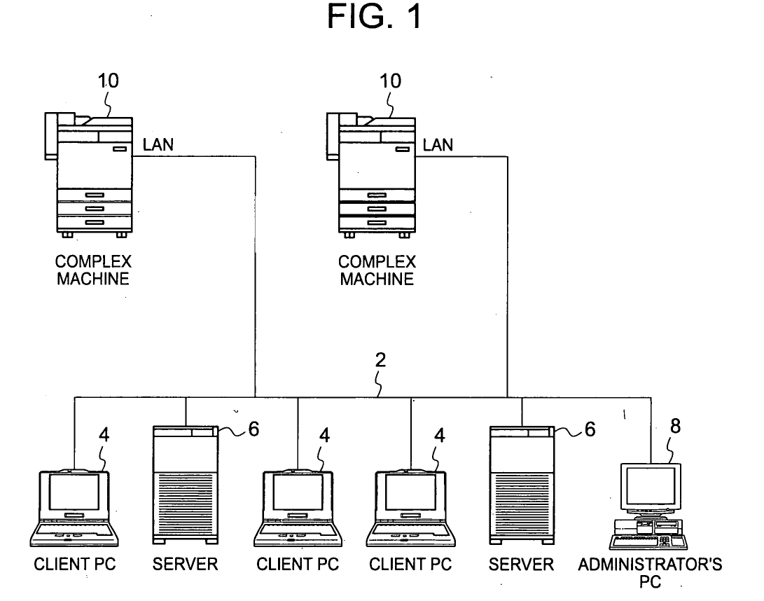

Referring to FIG. 1, there is shown a network system configuration including complex machines as remote processors according to this embodiment of the present invention. A complex machine 10 has a scanner function of reading an original image, a copying function of reading the original image and forming its copy image on recording paper, a printer function of forming an image corresponding to print data on recording paper, a facsimile function of transmitting or receiving the original image, and an e-mail transmitting function of automatically transmitting e-mail with an appended original image read using the scanner function to a specified destination.

The complex machine 10 is connected to a network 2 such as a local area network (LAN). Client PCs 4 including terminals and personal computers, various servers 6, and an administrator's PC 8 are connected to the network 2.

The complex machine 10 has a function of executing various jobs in response to a processing request received from one of the client PCs 4 via the network 2. It also has a function of authenticating an access right for an access from the client PC 4. The access right is a right to read or use (access) a file or data on the network. Phased limitations can be provided for it. For example, it is possible to regulate the use of important files on network settings or files on confidential in-house information so that only a specific user such as a system administrator can use the files. This disables someone to change network settings without permission, to view a confidential file, and to delete important files. Network management has the same meaning as of controlling the access rights. It is a right necessary for a client to use the functions of the complex machine 10 here.

The access right is authenticated by using authenticating information generated by combining a plurality of authentication elements. The authentication elements are user setting information and device-specific information specific to a client of an access source. The user setting information can be selected or set by a user like a user name (user ID), a user key (a password, etc.), and an e-mail address. The device-specific information includes a MAC address or an IP address of a client. The device-specific information is specific to a client and a user cannot change its settings arbitrarily, thereby enabling the client to be uniquely identified. The administrator or the user can modify the combination of the authentication elements composing the authenticating information. The complex machine 10 has a function of limiting the functions that can be used by the client individually.

Furthermore, the complex machine 10 has a hypertext transfer protocol (HTTP) server function and has a function of transmitting display data of a Web page in response to an access from a client PC using a Web browser. Various initializations by the administrator or initial registration requests from the user are made via the Web page.

The MAC address is a hardware address set for identifying a host on the network. In the Ethernet (TM), the MAC address is a 48-bit identification code allocated to a network interface card (NIC) and it is called an Ethernet address. The former 24 bits represent a vendor-specific ID managed by an institute of electrical and electronic engineers (IEEE), while the latter 24 bits represent a serial number of each NIC, which is an only one unique number in the world.

The IP address is a 32-bit address for identifying a computer on the TCP/IP network. It is represented by four figures marked off in units of 8 bits like [202.247.130.5]. Since it is hard for a user to handle it in a form of the figures, a domain name represented by characters like “aaabbb.ccc.co.jp” is used instead of the figures. IP addresses are allocated to all the computers connected to the Internet, respectively. The IP addresses of the computers connected to the LAN or the like are fixed. In a dial-up IP connection using a public circuit, however, a provider automatically allocates an IP address and therefore it varies for each connection.

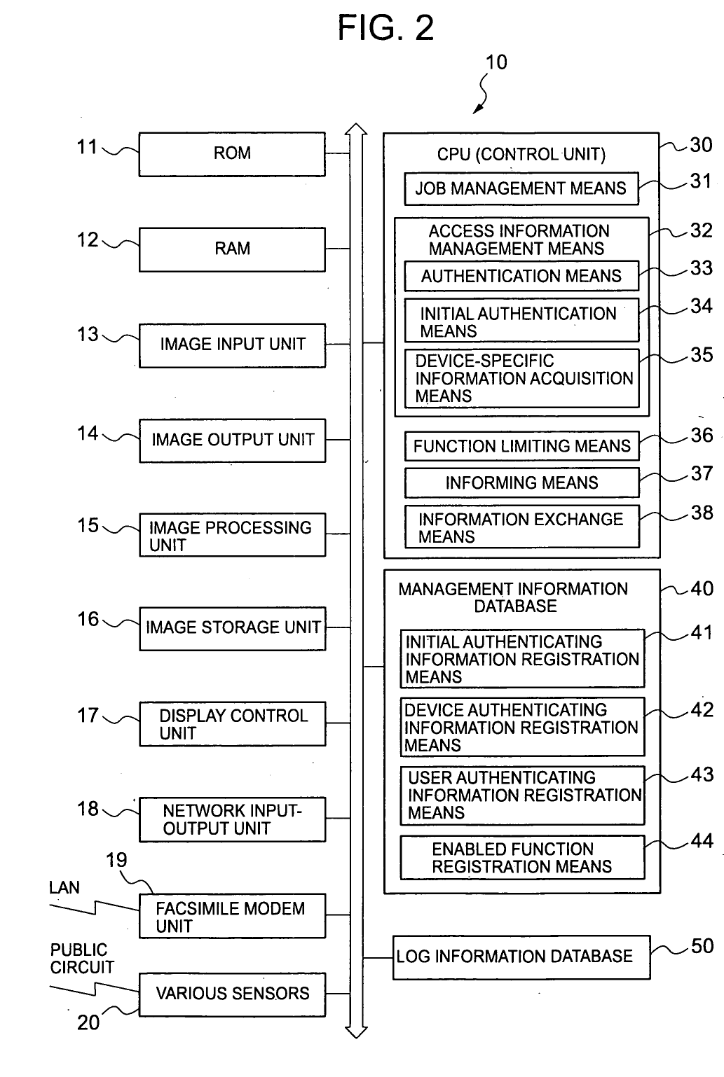

Referring to FIG. 2, there is shown a block diagram of a schematic configuration of the complex machine 10. The complex machine 10 comprises a central processing unit (CPU) 30 functioning as a control unit for controlling the entire operation of a device concerned and the CPU 30 is connected to various devices via buses. A read-only memory (ROM) 11 is a read-only memory storing programs executed by the CPU 30 or various fixed data. A random access memory (RAM) 12 functions as a work memory temporarily storing various data when the CPU 30 executes a program or as a page memory storing image data of at least one page.

An image input unit 13 carries out a function of reading an original image and capturing corresponding image data. The image input unit 13 is a scanner comprising a light source for irradiating the original with a light, a line image sensor for reading the original by a single line in the widthwise direction of the original, moving means for moving a position for reading in units of a line in the lengthwise direction of the original, and an optical path formed of a lens and a mirror guiding a reflected light from the original to the line image sensor so as to be focused on it. The line image sensor comprises, for example, a charge coupled device (CCD). Analog image signals output from the line image sensor are A-D converted and captured as digital image data.

An image output unit 14 carries out a function of forming and outputting an image corresponding to the image data on recording paper in an electrophotographic process. The image output unit 14 is a so-called laser printer having a recording paper feeder, a photosensitive drum, a charging device, a laser unit, a developing device, a transferring and separating device, a cleaning device, and a fixing device. An image processing unit 15 carries out a function of compressing or decompressing image data, a function of scaling up or down an image, and a function of rotating an image. An image storage unit 16 is a mass storage for storing compressed image data, facsimile data, and print data. In this specification, a hard disk drive (HDD) is used for it.

A display control unit 17 comprises a liquid crystal display with a touch panel on its surface and various operation switches, having a function of making various guide and status displays for a user or a function of accepting various operations sent from a user. A network input-output unit 18 carries out a function of interfacing with the network 2. A facsimile modem unit 19 carries out a communication function for facsimile transmission and reception and it is connected to a public circuit. In addition, various sensors 20 are connected to the CPU 30 in order to detect operational statuses of the complex machine 10.

A management information database 40 functions as authenticating information registration means for registering the authenticating information, which is a combination of the user setting information and device-specific information specific to a client. It registers various kinds of access control information on access right authentication. Furthermore, the management information database 40 functions as initial authenticating information registration means 41 having a registration of initial authenticating information for authenticating an access right initially, device authenticating information registration means 42 having a registration of device-specific information of a client PC 4 as device authenticating information, user authenticating information registration means 43 having a registration of user setting information as user authenticating information, and enabled function registration means 44 having a registration of functions enabled when an access right is successfully authenticated on the basis of the authenticating information for each authenticating information.

A log information database 50 carries out a function of recording log information on an access from the client PC 4. An access log is recorded in both cases where the access right authentication is successful and where it is unsuccessful. For example, if the access right authentication is unsuccessful, information acquired from an access source at the authentication such as an MAC address, an IP address, a user name, and a password of the access source and the accessed date are recorded as an access log.

The CPU 30 carries out functions of job management means 31, access information management means 32, function limiting means 36, informing means 37, and information exchange means 38. The job management means 31 carries out a function of controlling and managing an execution of a job to be a work unit such as a copying operation or a printing operation. The access information management means 32 is for use in managing the access right authentication or the like and has functions as authentication means 33, initial authentication means 34, and device-specific information acquisition means 35.

Upon receiving a processing request of a copying job or a print job from a client PC 4, the authentication means 33 authenticates an access right of the client PC 4 by using authenticating information, which is a combination of a plurality of authentication elements. Upon receiving an initial registration request from a client, the initial authentication means 34 carries out a function of authenticating the access right by using the initial authenticating information registered in the initial authenticating information registration means 41. If the initial authentication means 34 authenticates the access right successfully, the device-specific information acquisition means 35 automatically acquires device-specific information specific to the client from the client concerned and registers it on the device authenticating information registration means 42.

When the access right is successfully authenticated, the function limiting means 36 limits functions enabled for the current access to only enabled functions registered being associated with the authenticating information used for the access right authentication. The informing means 37 carries out a function of transmitting log information on a modification of access-control information based on an access from the client or log information on an unlawful access to a given administrator's terminal via the network. E-mail or a SNMP trap is used for the informing.

The information exchange means 38 carries out a function of transferring access control information between the complex machines 10 connected on the same network and each having a function of authenticating an access right or of limiting enabled functions by using the access control information such as authenticating information, thereby exchanging information so as to cause the respective complex machines 10 to have all the access control information.

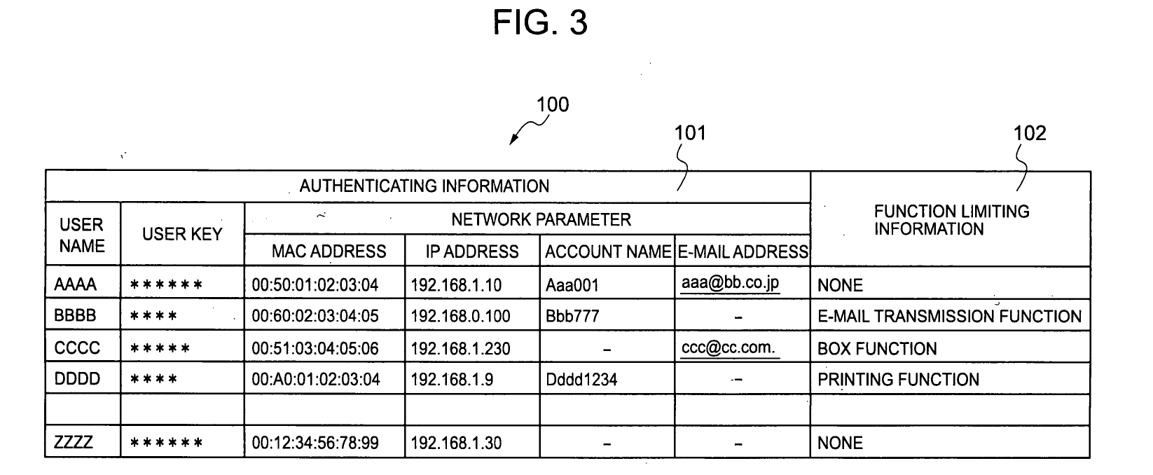

Referring to FIG. 3, there is shown an example of a registration table 100 listing access control information registered on the management information database 40. The registration table has a format including all of the information registered on the initial authenticating information registration means 41, the device authenticating information registration means 42, the user authenticating information registration means 43, and the enabled function registration means 44. In the registration table 100, each authenticating information is associated with the corresponding function limiting information. An authenticating information registration field 101 includes registrations of a user name (a user ID), a user key (a password or the like), a MAC address, an IP address, an account name, and an e-mail address as authentication elements composing the authenticating information. An administrator can specify authentication elements to be used as initial authenticating information or indispensable authentication elements composing the authenticating information. Information indicating which authentication elements have been specified for them is also registered as a part of the access control information, though it is not shown in the figure.

A function limiting information registration field 102 includes registrations of names of enabled functions. Instead of it, for example, it is also possible to register a function list marked at enabled functions associated with each authenticating information. Additionally, it is possible to register function limiting information on functions enabled by the administrator and function limiting information on functions limited by the user, respectively, though it is not shown in the figure. In this arrangement, the information is registered hierarchically in such a way that the functions enabled by the administrator are in a higher class and the functions limited by the user are in the lower class.

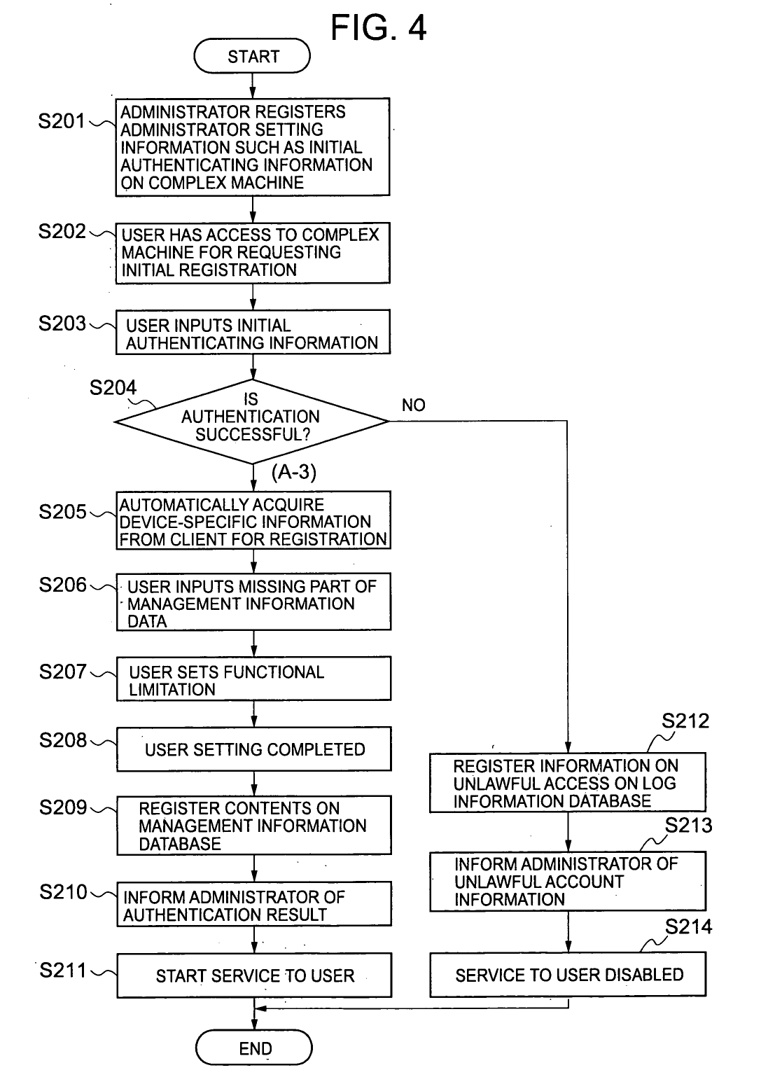

Referring to FIG. 4, there is shown a flow of processing on an initial registration request. The administrator registers administrator setting information such as initial authenticating information for use in authentication upon receiving the initial registration request from a client PC 4 (step S201). The registration of the administrator setting information is performed from the administrator's PC 8 via the network 2 and it is stored in the management information database 40 of the complex machine 10. In this embodiment, the administrator's PC 8 accesses the complex machine 10 by using a Web browser, encrypts the administrator setting information using a secure socket layer (SSL) or the like, and transmits it to the complex machine 10. The simple network management protocol (SNMP) or the Telnet can also be used besides the Internet. The management setting information can also be registered from the display control unit 17 of the complex machine 10.

The management setting information includes designations of authentication elements composing the authenticating information from the client PC 4 and function limiting information in the administrator class. As the initial authenticating information, a user name, a user key, or other user setting information is used in general. The administrator registers the administrator setting information for each complex machine 10 connected to the network 2 individually.

Thereafter, the user has access from the client PC 4 to the complex machine 10 for requesting the initial registration (step S202). In this embodiment, the user accesses a Web page for the initial registration registered on the HTTP server of the complex machine 10 by using a Web browser. The Web page shows a message prompting an input of the initial authenticating information previously specified by the administrator and its corresponding input field. For example, if the administrator specifies a user name and a user key for the initial authenticating information in a registration of the administrator setting information, a message prompting their inputs and their input fields are displayed.

After a user inputs the specified information in the input fields of the initial authenticating information and clicks on a “Send” key, the information for the initial authentication input by the user is transmitted to the complex machine 10 (step S203). At that time, it is preferable to encrypt it by using SSL. The initial authentication means 34 of the complex machine 10 compares the user-input information with the initial authenticating information registered on the initial authenticating information registration means 41 of the management information database 40 to authenticate an access right (step S204). More specifically, if the administrator presets a user name and a user key as the initial authenticating information, the access right authentication is performed using the user name and the user key.

If the authentication is successful (step S204: Y), the device-specific information acquisition means 35 automatically acquires device-specific information such as a MAC address and an IP address from the client PC 4 of an access source and registers them on the device authenticating information registration means 42 of the management information database 40 (step S205). Thereafter, a parameter input screen, which is not shown, is displayed on the user's client PC 4 to prompt an input of missing information (step S206). For example, it prompts an input of information still missing after the administrator automatically acquires the device-specific information out of the authentication elements specified as the authenticating information at the time of processing request or an input of missing information as indispensable information on the functions enabled by the administrator. For example, if the e-mail transmission function is enabled, an input of an e-mail address of a transmission destination is requested on the parameter input screen.

Furthermore, the user's client PC 4 displays a functional limitation setting screen, which is not shown, and accepts a setting for adding a functional limitation made by the user (step S207). The functional limitation setting screen shows setting contents of the functional limitations made by the administrator and accepts the addition of the functional limitation made by the user within a range enabled by the administrator. For example, if the administrator enables a printing function, the user can limit matters in the lower class of the printing function (the number of printed sheets, a double-sided printing function, etc.) arbitrarily. In a case of charging a fee, the user makes an additional setting within a range of an upper limit of an amount of money set by the administrator as a maximum amount charged for the use of the function, for example.

Upon completion of the user's input of the missing information and additional setting (step S208), the contents are registered on the management information database 40 (step S209). The informing means 37 informs the administrator of a result of the authentication for the current initial registration request (step S210). This completes the initial registration request, thereafter starting a service to the user (step S211) More specifically, the user is enabled to request the complex machine 10 of a job execution within the function-limited range from the client PC 4 used for the current initial registration request via the network 2.

If the authentication is unsuccessful (step S204: N), the information on the current unlawful access is registered on the log information database 50 (step S212) and the administrator is informed of the information on the current unlawful access (step S213). The information is transmitted by using e-mail or a SNMP trap. If the access right authentication is unsuccessful, the service to the user is not started (step S214).

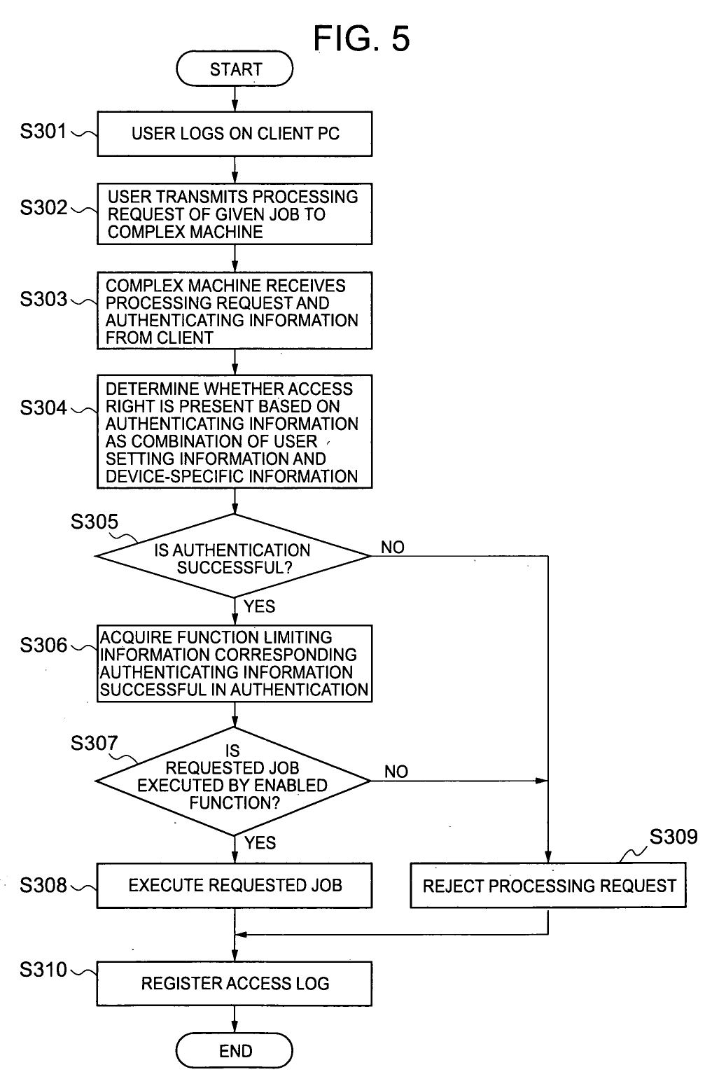

Referring to FIG. 5, there is shown a flow of processing performed when a user requests the complex machine 10 of a job execution from the client PC via the network. The user logs on the client PC 4 used for requesting the initial registration (step S301). When the user logs on, the client PC 4 performs user authentication by using a user name (a user ID) and a user key (a password). The user transmits a processing request of a desired job from the client PC 4 to the complex machine 10 (step S302).

For example, the user requests printing from word processor software by using a general-purpose printer driver, by which the processing request of a print job is transmitted from the client PC 4 to the complex machine 10 via the network 2. At that time, the device-specific information such as an IP address and a MAC address of the client PC 4 and the user setting information such as a user name are transmitted as the authentication-related information to the complex machine 10 together with the print data.

The complex machine 10 receives the job processing request and the authentication-related information transmitted from the client PC 4 (step S303) and compares the authenticating information registered on the management information database 40 with the received authentication-related information to authenticate the access right (step S304).

The authenticating information is a combination of the user setting information and the device-specific information. The access right is authenticated on the basis of all the authentication elements composing the authenticating information as conditions logically ANDed. For example, if the administrator presets a user name and a MAC address as the authenticating information, the access right authentication is successful only when a match occurs in these two authentication elements.

If the access right is successfully authenticated (step S305: Y), the complex machine 10 reads out the function limiting information registered being associated with the authenticating information used for the current authentication from the registration table 100 (step S306) and determines whether the function related to the current requested job execution is enabled (step S307). If it is enabled (step S307: Y), it executes the requested job (step S308) and registers log information related to the current access after the execution on the log information database 50 (step S310).

If the access right authentication is unsuccessful (step S305: N) and if the function related to the requested job execution is not enabled while the access right is successfully authenticated (step S307: N), the complex machine 10 rejects the job execution related to the current processing request (step S309) and registers the log information related to the current access on the log information database 50 (step S310).

The complex machine 10 uses the authenticating information, which is a combination of the user setting information and the device-specific information, as stated above, by which the access right is authenticated using the user authentication and the client authentication as conditions logically ANDed. Thus, security for remote accesses is improved in comparison with a case of authenticating the access right only using user authentication base on the user setting information such as a password. Furthermore, enabled functions can be limited for each authenticating information and therefore it is possible to conduct careful management of remote uses of the complex machines 10.

The following describes processing for exchanging access management information between complex machines 10 connected on the same network.

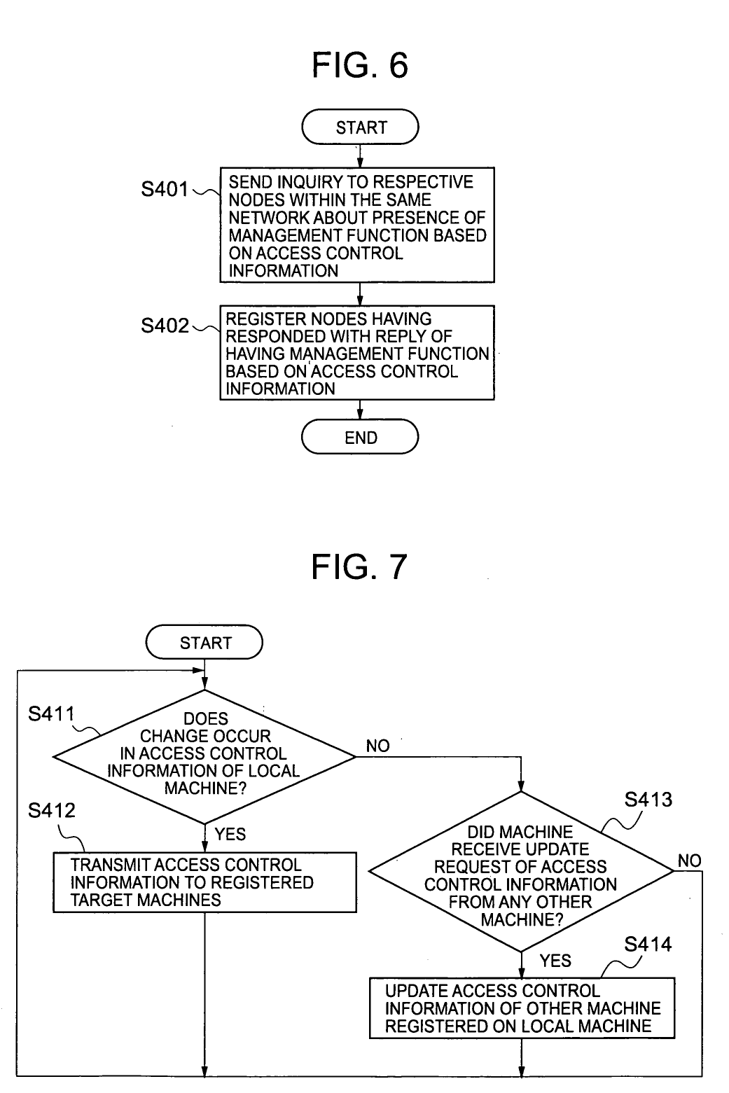

Referring to FIG. 6, there is shown a flow of node check processing for searching for the complex machine 10 with which information is to be exchanged within the same network. This processing is executed when the complex machine 10 is turned on or at every turn of a given check period. For example, the processing is executed at a specific time every day. First, an inquiry is sent to all the nodes within the same network about the presence or absence of an access right management function using access control information (step S401). More specifically, a multicast packet for inquiring about the presence or absence of the above management function is transmitted to the network. Nodes having responded with a reply of having the management function to the inquiry are registered as target devices for delivering the access control information (step S402).

Referring to FIG. 7, there is shown a flow of processing on information exchanges.

If any change occurs in the access control information registered in the local machine due to a registration of the administrator setting information or an initial registration request from the client PC 4 shown in FIG. 4 (step S411: Y), the complex machine transmits access management information after the change to each of the target machines registered in the above node check processing. In the transmission, preferably encryption is applied. It is possible to transmit all or only the changed part of the access control information to each target machines. If the machine receives access control information from any other machine (step S413: Y), it updates the access control information registered on the local machine according to the received information (step S414).

This causes all the complex machines 10 connected on the same network and having the management function with the access control information to have the same access control information. In other words, the administrator and the user can request any machine connected on the same network to register administrator setting information, to make an initial registration, and to execute job processing only if it is a complex machine 10 having the management function. Furthermore, all the complex machines 10 have the same information regarding the function limiting information for each authenticating information. Therefore, functional limitations having the same contents are applied even if an accessed machine is any complex machine 10 within the network only if the same authenticating information is used for the access right authentication.

With the information exchanges as stated above, the unified access right authentication or functional limitation can be performed on the same network without a provision of a dedicated management server. If a dedicated management server is provided, a failure of the management server disables a remote use in all the complex machines 10. This situation does not occur in the present invention. Even if one of the complex machines 10 breaks down, other complex machines 10 are available. Furthermore, the load is shared. The arrangement may be such that the search for target machines or the information exchange is performed on the basis of manual instructions from a user or an administrator.

While the preferred embodiment of the present invention has been described with referring to the accompanying drawings, a concrete arrangement of the present invention is not limited to the preferred embodiment. On the contrary, it is intended to include all arrangements having changes or additions without departing from the scope of the invention. For example, while the embodiment has been described by giving an example of a complex machine as a remote processor, it is only required to have a function of executing processing whose request is sent from a client via the network like a printer or a facsimile machine.

While only the user setting information such as a user name and a user key is used as the initial authenticating information in the embodiment, the administrator can check device-specific information of a client such as a MAC address and add it to the initial authenticating information. For example, the administrator's PC 8 may access a client PC 4 to acquire a MAC address and an IP address and they can be automatically set as a part or all of the initial authenticating information of the administrator setting information.

While a general-purpose driver software is used when a print job request is sent from the client PC 4 to the complex machine 10 in this embodiment, it is possible to use dedicated driver software that can automatically output various information necessary for the access right authentication. This enables an automatic output of information necessary for the authentication without increasing an operational burden on a user, for example, also when an e-mail address is set as one of the authentication elements.

The arrangement may be such that a user can make settings of a combination of authentication elements composing authenticating information at the time of requesting the initial registration or that a user can add authentication elements to authenticating information preset by an administrator.

While log information on an access is transmitted to an administrator for each access from a client PC 4 in this embodiment, it is possible to transmit the information at every turn of a given informing period or every time a specific condition is satisfied or to transmit the information according to an informing request from an administrator. For example, log information of a day is transmitted collectively to the administrator at a specific time every day. Furthermore, in case of receiving an unlawful access a given or greater number of times from the same access source within a given period, log information on the unlawful access is preferably transmitted to the administrator.

Although only some exemplary embodiments of this invention have been described in detail above, those skilled in the art will readily appreciate that many modifications are possible in the exemplary embodiments without materially departing from the novel teachings and advantages of this invention. Accordingly, all such modifications are intended to be included within the scope of this invention.

1. A remote processor for executing processing requested from a client via a network, comprising:
authenticating information registration means having authenticating information registered, which is a combination of user-configurable user setting information and device-specific information specific to the client; and
authentication means for authenticating an access right by comparing information for use in the authentication acquired from the client with the authenticating information registered on the authenticating information registration means upon receiving a processing request from the client.

2. A remote processor for executing processing requested from a client via a network, comprising:
initial authenticating information registration means having initial authenticating information registered for initially authenticating an access right;
initial authentication means for authenticating the access right on the basis of the initial authenticating information upon receiving an initial registration request from the client;
device-specific information acquisition means for acquiring device-specific information, which is specific to the client, from the client if said initial authentication means authenticates the access right;
device authenticating information registration means for registering the device-specific information acquired by said device-specific information acquisition means as device authenticating information; and
authentication means for authenticating the access right by using authenticating information including a part or all of the device authenticating information upon receiving a processing request from the client.

3. The remote processor according to claim 2, further comprising user authenticating information registration means having user-configurable user setting information registered, wherein said authentication means authenticates the access right by using authenticating information which is a combination of the user setting information and the device authenticating information.

4. The remote processor according to claim 1, further comprising:
enabled function registration means having functions registered for enablement for each authenticating information if the access right is successfully authenticated on the basis of the authenticating information; and
function limiting means for limiting functions enabled for the current access to only enabled functions registered being associated with the authenticating information used for authenticating the access right if the access right is successfully authenticated.

5. The remote processor according to claim 1, further comprising information exchange means for transferring access control information composed of information for access right authentication or function limitation between remote processors, which are connected on the same network and each having a function of authenticating an access right or limiting enabled functions by using the access control information, in order to exchange information so that the respective remote processors have all the access control information.

6. The remote processor according to claim 1, further comprising informing means for informing a given administrator's terminal of log information on the access from the client via the network.
